(19) United States
(12) Patent Application Publication
(10) Pub. No.: US 2013/0179528 A1
(43) Pub. Date: Jul. 11, 2013

(54) USE OF MULTICORE PROCESSORS FOR NETWORK COMMUNICATION IN CONTROL SYSTEMS

(71) Applicants: Dino A. Gianisis, Binghamton, NY (US); Michael G. Adams, Endwell, NY (US); Eric F. Davis, Vestal, NY (US)

(72) Inventors: Dino A. Gianisis, Binghamton, NY (US); Michael G. Adams, Endwell, NY (US); Eric F. Davis, Vestal, NY (US)

(73) Assignee: BAE SYSTEMS CONTROLS, INC., Johnson City, NY (US)

(21) Appl. No.: 13/347,869

(22) Filed: Jan. 11, 2012

(51) Int. Cl. G06F 15/167

(52) U.S. Cl. 709/213

(57) ABSTRACT

Various embodiments of the present invention relate to use of one or more multicore processors for network communication (e.g., Ethernet-based communication) in control systems (e.g., vehicle control systems, medical control systems, hospital control systems, instrumentation control systems, test instrument control systems, energy control systems and/or industrial control systems). In one example, one or more systems may be provided with regard to use of multicore processor(s) for network communication (e.g., Ethernet-based communication) in control systems. In another example, one or more methods may be provided with regard to use of multicore processor(s) for network communication (e.g., Ethernet-based communication) in control systems.

### BACKGROUND OF THE INVENTION

1. Field of the Invention

Various embodiments of the present invention relate to use of one or more multicore processors for network communication (e.g., Ethernet-based communication) in control systems (e.g., vehicle control systems, medical control systems, hospital control systems, instrumentation control systems, test instrument control systems, energy control systems and/or industrial control systems). In one example, one or more systems may be provided with regard to use of multicore processor(s) for network communication (e.g., Ethernet-based communication) in control systems. In another example, one or more methods may be provided with regard to use of multicore processor(s) for network communication (e.g., Ethernet-based communication) in control systems.

In another example, the vehicle may be an aerospace vehicle (e.g., an airplane, an aircraft, and/or a space vehicle (e.g. space shuttle, rocket and/or satellite)). In another example, the vehicle may be a ground vehicle (e.g., a wheeled vehicle and/or a tracked vehicle). In another example, the vehicle may be a car or a truck or bus or a tank or a train or a boat or a ship or a submarine. In another example, the vehicle may be a manned vehicle. In another example, the vehicle may be an unmanned vehicle.

For the purposes of describing and claiming the present invention, the term “multicore processor” is intended to refer to a single computing component with two or more independent processors (called “cores”), which are the units that read and execute program instructions.

For the purposes of describing and claiming the present invention, the term “core” is intended to refer to a single one of the plurality of independent processors in a multicore processor.

For the purposes of describing and claiming the present invention, the term “deterministic network communication protocol” is intended to refer to a network communication protocol that provides predictable behavior along with guaranteed delivery of messages and/or data within a defined time period. In one example, such a deterministic network communication protocol may be the ARINC 664 Part 7 protocol. In another example, such a deterministic network communication protocol may be the Time Triggered Ethernet—SAE AS6802 protocol. In another example, such a deterministic network communication protocol may be the IEEE 1588 protocol.

For the purposes of describing and claiming the present invention, the term “ARINC 664 Part 7 protocol” is that named protocol as promulgated by ARINC as of the date of filing of the present application, as may be superseded by any duly promulgated successors or as may be amended by any duly promulgated amendments. The entire contents of the ARINC 664 Part 7 protocol is incorporated by reference herein in its entirety.

For the purposes of describing and claiming the present invention, the term “Time Triggered Ethernet—SAE AS6802 protocol” is that named protocol as promulgated by the SAE (Society of Automotive Engineers) as of the date of filing of the present application, as may be superseded by any duly promulgated successors or as may be amended by any duly promulgated amendments. The entire contents of the Time Triggered Ethernet—SAE AS6802 protocol is incorporated by reference herein in its entirety.

For the purposes of describing and claiming the present invention, the term “IEEE 1588 protocol” is that named protocol as promulgated by the IEEE (Institute of Electrical and Electronic Engineers) as of the date of filing of the present application, as may be superseded by any duly promulgated successors or as may be amended by any duly promulgated amendments. The entire contents of the IEEE 1588 protocol is incorporated by reference herein in its entirety.

For the purposes of describing and claiming the present invention, the term “network communication” is intended to refer to bi-directional communication between at least first and second endpoints, or nodes.

For the purposes of describing and claiming the present invention, the term “a memory” or “the memory” is intended to refer to a single physical memory device or a plurality of physical memory devices (e.g., a memory “bank”).

For the purposes of describing and claiming the present invention, the term “a memory location” or “the memory location” is intended to refer to a single memory address or a plurality of memory addresses (e.g., a plurality of non-contiguous memory addresses or a range of contiguous memory addresses).

For the purposes of describing and claiming the present invention, the term “shared memory” is intended to refer to memory that may be accessed (e.g., essentially simultaneously accessed) by multiple programs and/or cores with an intent to provide communication among them and/or to avoid redundant copies. Shared memory may include a single memory address or a plurality of memory addresses (e.g., a plurality of non-contiguous memory addresses or a range of contiguous memory addresses).

For the purposes of describing and claiming the present invention, the term “physical layer” is intended to refer to the first and lowest layer in the seven-layer OSI model of computer networking.

For the purposes of describing and claiming the present invention, the term “AFDX” (or “avionics full-duplex switched Ethernet”) is intended to refer to a data network for safety-critical applications that utilizes dedicated bandwidth while providing deterministic quality-of-service (AFDX is an implementation of ARINC 664 part 7).

For the purposes of describing and claiming the present invention, the term “TTEthernet” is intended to refer to a computer network technology marketed by TTTech Computertechnik AG for use in airplanes and other real-time applications.

For the purposes of describing and claiming the present invention, the term “FPGA” (or “field-programmable gate array”) is intended to refer to an integrated circuit designed to be configured by the customer or designer after manufacturing.

For the purposes of describing and claiming the present invention, the term “ASIC” (or “application-specific integrated circuit”) is intended to refer to an integrated circuit customized for a particular use, rather than intended for general purpose use.

For the purposes of describing and claiming the present invention, the term “DMA controller” (or “direct memory access controller”) is intended to refer to a mechanism that allows certain hardware subsystems within a computer to access system memory for reading and/or writing independently of the central processing unit (CPU).

For the purposes of describing and claiming the present invention, the term “DDR memory” (or “double data rate memory”) is intended to refer to a class of memory integrated circuits used in computers.

For the purposes of describing and claiming the present invention, the term “L2 Cache memory” is intended to refer to a class of memory integrated circuits used in computers.

2. Description of Related Art

Modern aerospace and ground vehicle control systems that use deterministic Ethernet-based communication protocols (such as, for example, ARINC 664 Part 7, Time Triggered Ethernet—SAE AS6802, and IEEE 1588) traditionally require either a dedicated single core processor, FPGA, or ASIC to manage the communication protocol (as distinct from any other processor(s) dedicated to the control system application itself).

### SUMMARY OF THE INVENTION

In one embodiment of the present invention a multicore communication processor such as found in the Freescale Semiconductor™ QorIQ family is used as the multicore processor. In one example, control system application processing and various network communication protocol processing (e.g., Ethernet-based communication protocol processing) are integrated into a single multicore processor. The present invention eliminates the need for a dedicated single core processor, FPGA or ASIC device to manage the communication protocol. In another example, this reduces the size, weight and cost of the overall control system (as opposed to the above-mentioned traditional use of either a dedicated single core processor, FPGA or ASIC to manage the communication protocol). In another example, any desired multicore processor device or devices (e.g., with embedded Ethernet-based communication protocol processing) may be utilized.

In another embodiment a control system is provided, wherein the control system uses a multicore processor to perform network communication with a device. In this embodiment, the control system comprises a memory including at least a first memory location and a second memory location. The control system of this embodiment further comprises at least a first core for executing a control application, wherein the first core is part of the multicore processor, wherein the control application comprises a plurality of machine-readable instructions, wherein the machine-readable instructions of the control application are stored at the first memory location and are accessible (and/or used) by the first core. In addition, the control system of this embodiment further comprises at least a second core for executing a network communication with the device, wherein the second core is in operative communication with the first core, wherein the network communication conforms with a communication protocol, and wherein a plurality of machine-readable instructions for performing the network communication in conformance with the communication protocol are stored at the second memory location and are accessible (and/or used) by the second core. Moreover, in this embodiment, the network communication associated with the second core controls the device based at least in part upon at least one command from the control application associated with the first core.

In another embodiment a control system is provided, wherein the control system uses a multicore processor to perform network communication with a first device and a second device. The control system of this embodiment further comprises a shared memory. In addition, the control system of this embodiment further comprises at least a first core for executing a first control application, wherein the first core is part of the multicore processor, wherein the first control application comprises a plurality of machine-readable instructions, wherein the machine-readable instructions of the first control application are stored at a first memory location accessible (and/or used) by the first core, and wherein the shared memory is accessible (and/or used) by the first core. In addition, the control system of this embodiment further comprises at least a second core for executing a second control application, wherein the second core is part of the multicore processor, wherein the second control application comprises a plurality of machine-readable instructions, wherein the machine-readable instructions of the second control application are stored at a second memory location accessible (and/or used) by the second core; and wherein the shared memory is accessible (and/or used) by the second core. In addition, the control system of this embodiment further comprises at least a third core for executing a network communication, wherein the network communication conforms with a network communication protocol, wherein a plurality of machine-readable instructions for performing the network communication in conformance with the network communication protocol are stored at a third memory location accessible (and/or used) by the third core, wherein the shared memory is accessible (and/or used) by the third core. Moreover, in this embodiment: at least some network data associated with the network communication is made available in the shared memory by the third core; wherein each of the first core and the second core has access to at least some of the network communication data made available in the shared memory by the third core; wherein the first core is in operative communication with the third core and the network communication associated with the third core controls the first device based at least in part upon at least one command from the first control application associated with the first core; and wherein the second core is in operative communication with the third core and the network communication associated with the third core controls the second device based at least in part upon at least one command from the second control application associated with the second core

In another embodiment, a method for use in connection with a control system is provided, wherein the control system uses a multicore processor to perform network communication with a device, and wherein the multicore processor includes at least a first core and a second core. The method of this embodiment further comprises storing a plurality of machine-readable instructions for performing control of the device at a memory location to be used (and/or accessible) by the first core. In addition, the method of this embodiment further comprises selecting one of a plurality of network communication protocols for use with the control system. In addition, the method of this embodiment further comprises storing a plurality of machine-readable instructions for performing the network communication in conformance with the selected network communication protocol at a memory location to be used (and/or accessible) by the second core. Moreover, in this embodiment, the network communication associated with the second core is configured to control the device based at least in part upon at least one command from the plurality of machine-readable instructions for performing control of the device that are associated with the first core.

### BRIEF DESCRIPTION OF THE DRAWINGS

The drawings are provided for illustrative purpose only and do not necessarily represent practical examples of the present invention to scale. In the figures, same reference signs are used to denote the same or like parts.

FIG. 1 is a block diagram of a system according to one embodiment of the present invention;

FIG. 2 is a block diagram of a system according to another embodiment of the present invention;

FIG. 3 is a block diagram of a system according to another embodiment of the present invention;

FIG. 4 is a block diagram of a system according to another embodiment of the present invention; and

FIG. 5 is a block diagram of a method according to another embodiment of the present invention.

### DETAILED DESCRIPTION OF THE INVENTION

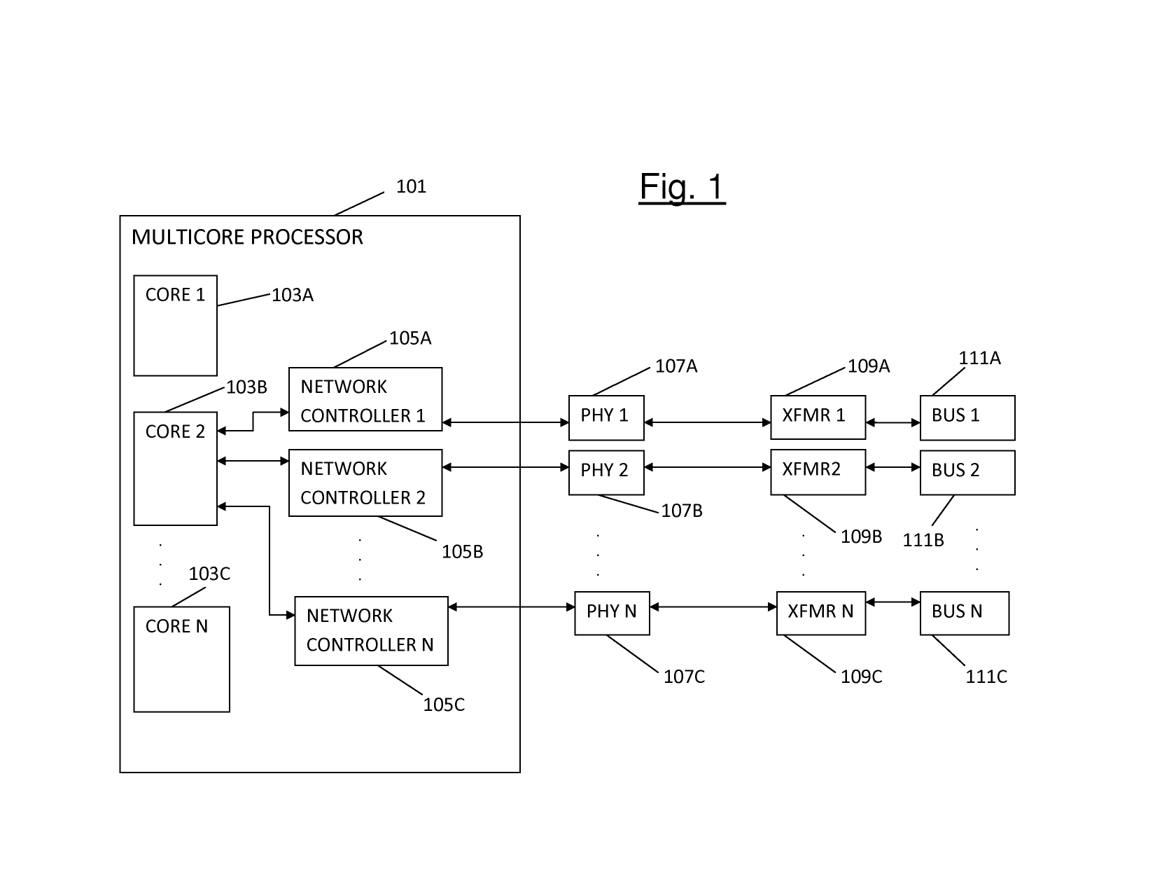

Referring now to FIG. 1, a block diagram of a system according to an embodiment of the present invention is shown. As seen in FIG. 1, multicore processor 101 includes a plurality of cores: a first core (Core 1 —103A), a second core (Core 2 —103B), and a third core (Core n —103C). Of course, the three cores shown in this FIG. 1 are intended as an example, and any desired number of cores may be utilized. Further, one or more of the cores 103A, 103B, 103C may be in operative communication with one or more of the other cores 103A, 103B, 103C (in one example, the operative communication may be carried out via direct communication paths (not shown); in another example, the operative communication may be carried out via use of shared memory (not shown)).

Still referring to FIG. 1, it is seen that multicore processor 101 also includes a plurality of network controllers: a first network controller (Network Controller 1 —105A), a second network controller (Network Controller 2 —105B), and a third network controller (Network Controller n 105C). Each of the network controllers 105A, 105B and 105C operatively communicates (bi-directionally) with Core 2 —103B. Of course, the three network controllers shown in this FIG. 1 are intended as an example, and any desired number of network controllers may be utilized. Further, the network controllers 105A, 105B and 105C may communicate with any desired core(s).

Still referring to FIG. 1, it is seen that a plurality of physical layers may be provided: a first physical layer (Physical Layer 1—107A), a second physical layer (Physical Layer 2—107B), and a third physical layer (Physical Layer 3—107C). As seen, each network controller may communicate (bi-directionally) with a respective one of the physical layers. Of course, the three physical layers shown in this FIG. 1 are intended as an example, and any desired number of physical layers may be utilized. In another example, all of the network controllers may communicate with a single physical layer.

Still referring to FIG. 1, it is seen that a plurality of transformers may be provided: a first transformer (XFMR 1 —109A), a second transformer (XFMR 2 —109B), and a third transformer (XFMR 3 —109C). As seen, each transformer may communicate (bi-directionally) with a respective one of the physical layers. Of course, the three transformers shown in this FIG. 1 are intended as an example, and any desired number of transformers may be utilized. In another example, all of the transformers may communicate with a single physical layer.

Still referring to FIG. 1, it is seen that a plurality of buses may be provided: a first bus (Bus 1 —111A), a second bus (Bus 2—111B), and a third bus (Bus 3 —111C). As seen, each bus may communicate (bi-directionally) with a respective one of the transformers. Of course, the three buses shown in this FIG. 1 are intended as an example, and any desired number of buses may be utilized.

Still referring to FIG. 1, it is noted that in one specific example, the Multicore Processor 101 may comprise a QorIQ multicore processor (available from Freescale Semiconductor™). In another specific example, one, a plurality of, or all of the network controllers may comprise Ethernet controllers. In another specific example, one, a plurality of, or all of the network controllers may comprise enhanced triple speed Ethernet controllers (“eTSEC”). In another specific example, one, a plurality of, or all of the physical layers may comprise 10/100/1000 MBit interfaces (“Phy 10/100/1000”). In another specific example, one, a plurality of, or all of the buses may comprise AFDX buses. In another specific example, Core 2 (block diagram element 103B) may be an “AFDX Processor” (that is, assigned to AFDX processing). In another specific example, one, a plurality of, or all of the buses may comprise ARINC 664 part 7 buses. In another specific example, Core 2 (block diagram element 103B) may be an “ARINC 664 part 7 Processor” (that is, assigned to ARINC 664 part 7 processing). In another specific example, one, a plurality of, or all of the buses may comprise TTEthernet buses. In another specific example, Core 2 (block diagram element 103B) may be an “TTEthernet Processor” (that is, assigned to TTEthernet processing). In another specific example, different bus(es) may carry different protocols. In another specific example, one or more buses may be assigned to various protocols and one or more buses may be kept reserved (or available) for assignment to a protocol when desired.

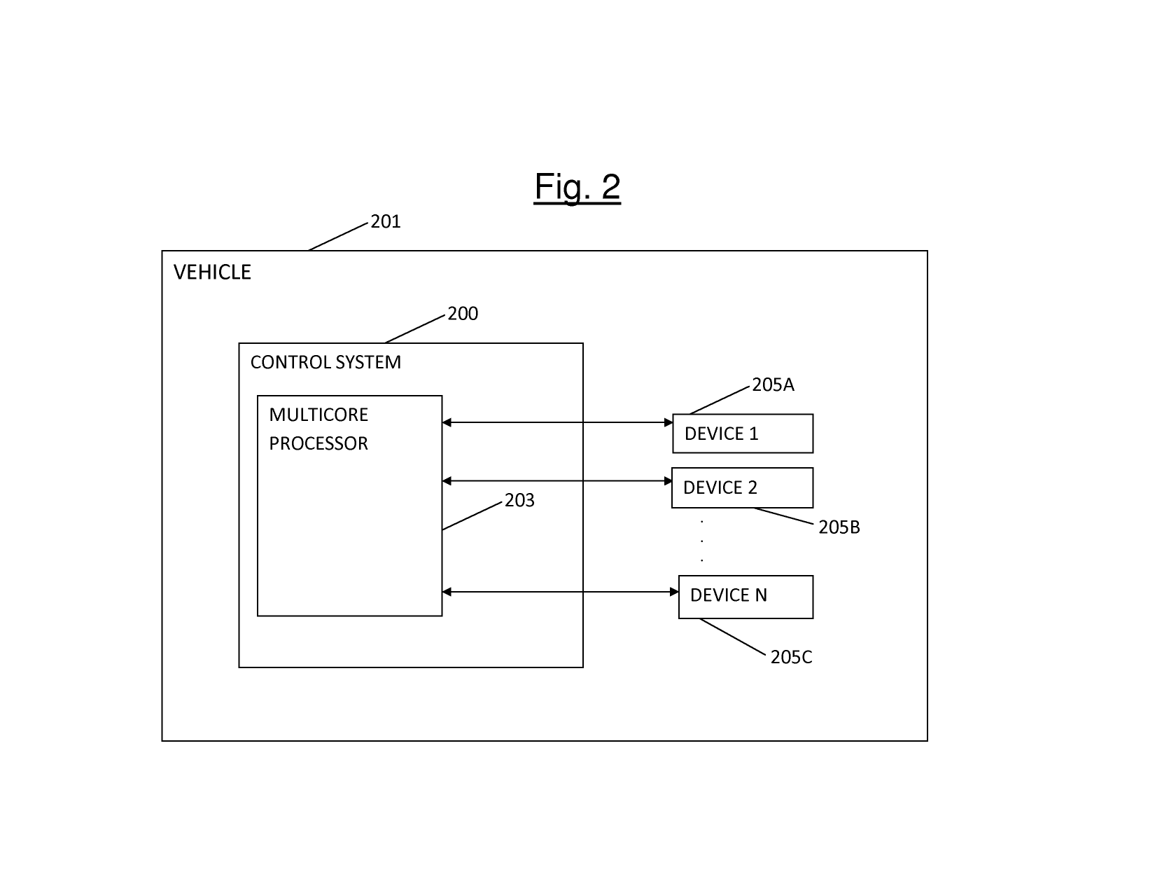

Referring now to FIG. 2, a block diagram of a Control System 200 (for use with a Vehicle 201) according to another embodiment of the present invention is shown. Of note, as mentioned herein, other embodiments of the present invention may be used in any other desired context (e.g., medical control system, hospital control system, instrumentation control system, test instrument control system, energy control system and/or industrial control system). In any case, as seen in this FIG. 2, Control System 200 includes Multicore Processor 203 (for clarity, the inner elements of Multicore Processor 203 are not shown in this FIG. 2; in one example, this Multicore Processor 201 may be of the type shown in FIG. 1 and may include a plurality of cores and a plurality of network controllers).

Still referring to FIG. 2, it is seen that Vehicle 201 includes a plurality of devices: a first device (Device 1 —205A), a second device (Device 2 —205B), and a third device (Device n 205C). Each of the devices 205A, 205B and 253C operatively communicates (bi-directionally) with Multicore Processor 203 (for clarity, the elements of each communication path between a respective one of devices 205A, 205B, 205C and Multicore Processor 203 are not shown in this FIG. 2; in one example, each communication path may be of the type shown in FIG. 1 and may include a physical layer, a transformer and a bus). Of course, the three devices shown in this FIG. 2 are intended to be an example, and any desired number of devices may be utilized.

In another example, each device may be selected from the group including (but not limited to): an engine, a motor, an actuator (e.g., a linear actuator), a control surface, a navigation device, a communication device.

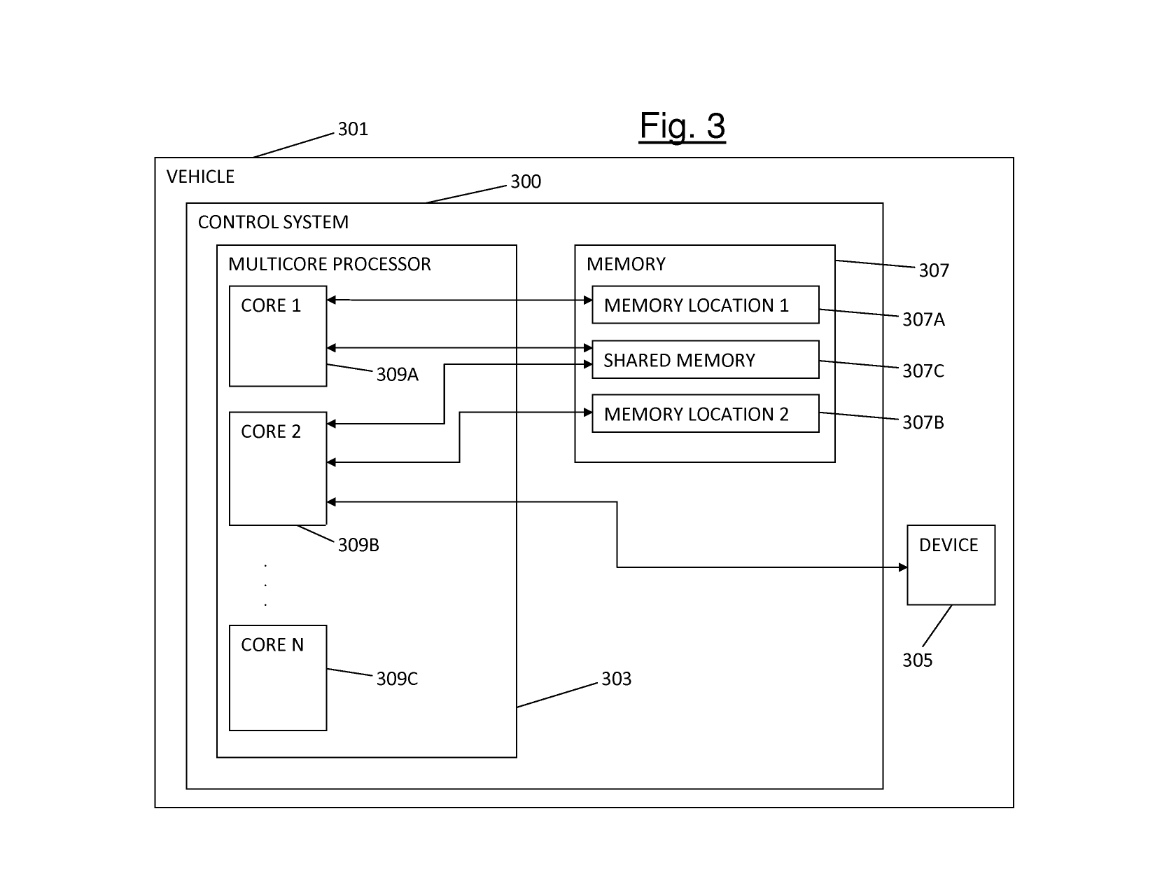

Referring now to FIG. 3, a block diagram of a Control System 300 (for use with a Vehicle 301) according to another embodiment of the present invention is shown. Of note, as mentioned herein, other embodiments of the present invention may be used in any other desired context (e.g., medical control system, hospital control system, instrumentation control system, test instrument control system, energy control system and/or industrial control system). In any case, seen in this FIG. 3, Control System 300 includes Multicore Processor 303 to perform network communication with a Device 305. The Control System 300 comprises a Memory 307 having at least a first memory location (Memory Location 1 —307A), a second memory location (Memory Location 2 —307B) and a Shared Memory 307C). Also provided is at least a first core (Core 1 —309A) that executes a vehicle control application, wherein the first core (Core 1 —309A) is part of the Multicore Processor 303, wherein the vehicle control application comprises a plurality of machine-readable instructions, and wherein the machine-readable instructions of the vehicle control application are stored at the first memory location (Memory Location 1 —307A) that is accessed by the first core (Core 1 —309A). Also provided is at least a second core (Core 2 —309B) that executes a network communication with the Device 305; wherein the second core (Core 2 —309B) is in operative communication with the first core (Core 1 —309A), wherein the network communication conforms with a communication protocol, and wherein a plurality of machine-readable instructions for performing the network communication in confoiniance with the communication protocol are stored at the second memory location (Memory Location 2 —307B) that is accessed by the second core (Core 2 —309B). As described herein, the network communication associated with the second core (Core 2 —309B) controls the Device 305 based at least in part upon at least one command from the vehicle control application associated with the first core (Core 1 —309A). As further described herein, the network communication protocol comprises a deterministic network communication protocol. In addition, as seen, the Multicore Processor 303 may include a third core (Core n 309C). In one example, the operative communication between the first core (Core 1 —309A) and the second core (Core 2 —309B) may be carried out via use of the Shared Memory 307C. In another example, all or part of Memory 307 may reside within the Multicore Processor 303.

Of course, the three cores shown in this FIG. 3 are intended to be an example, and any desired number of cores may be utilized. Further, the single memory shown in this FIG. 3 is intended to be an example, and any desired number of memories may be utilized. Further, the two memory locations shown in this FIG. 3 are intended to be an example, and any desired number of memory locations may be utilized. Further, the single shared memory shown in this FIG. 3 is intended to be an example, and any desired number of shared memories may be utilized. Further, the single device shown in this FIG. 3 is intended to be an example, and any desired number of devices may be utilized.

Still referring to FIG. 3, in one example, the device being controlled may be controlled based at least in part upon a plurality of commands from the vehicle control application associated with Core 1 —309A. In another example, the command(s) from the vehicle control application associated with Core 1 —309A may be based at least in part upon datum or data provided from the device to the first core via the network communication associated with Core 2 —309B.

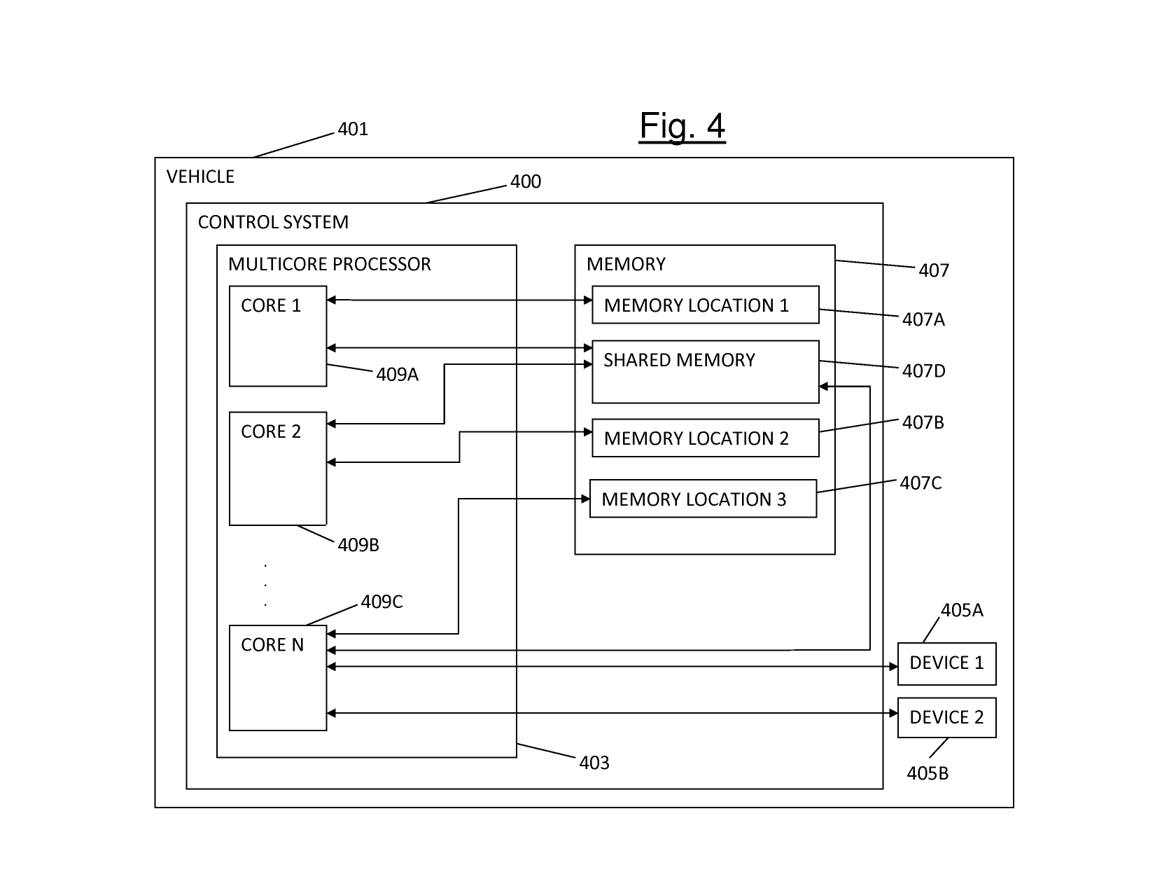

Referring now to FIG. 4, a block diagram of a Control System 400 (for use with a Vehicle 401) according to another embodiment of the present invention is shown. Of note, as mentioned herein, other embodiments of the present invention may be used in any other desired context (e.g., medical control system, hospital control system, instrumentation control system, test instrument control system, energy control system and/or industrial control system). In any case, as seen in this FIG. 4, Control System 400 includes a Multicore Processor 403 to perforin network communication with a first device (Device 1 —405A) and a second device (Device 2 —405B). The control system comprises a Memory 407 including at least a first memory location (Memory Location 1 —407A), a second memory location (Memory Location 2 —407B), a third memory location (Memory Location 3 —407C), and Shared Memory 407D. Also provided is at least a first core (Core 1 —409A) executing a first vehicle control application, wherein the first core (Core 1 —409A) is part of the Multicore Processor 403, wherein the first vehicle control application comprises a plurality of machine-readable instructions, wherein the machine-readable instructions of the first vehicle control application are stored at the first memory location (Memory Location 1 —407A) that is accessed by the first core (Core 1 —409A), and wherein the Shared Memory 407D is accessible by the first core (Core 1 —409A). Also provided is at least a second core (Core 2 —409B) executing a second vehicle control application, wherein the second core (Core 2 —409B) is part of the Multicore Processor 403, wherein the second vehicle control application comprises a plurality of machine-readable instructions, wherein the machine-readable instructions of the second vehicle control application are stored at the second memory location (Memory Location 2 —407B) that is accessed by the second core (Core 2 —409B), and wherein the Shared Memory 407D is accessible by the second core (Core 2 —409B). Also provided is at least a third core (Core n —409C), executing a network communication, wherein the network communication conforms with a network communication protocol, wherein a plurality of machine-readable instructions for performing the network communication in conformance with the network communication protocol are stored at the third memory location (Memory Location 3 —407C) that is accessed by the third core (Core n —409C), wherein the Shared Memory 407D is accessible by the third core (Core n —409C). As described herein, at least some network data associated with the network communication is made available in the Shared Memory 407D by the third core (Core n —409C); wherein each of the first core (Core 1—409A) and the second core (Core 2 —409B) has access to at least some of the network communication data made available in the Shared Memory 407D by the third core (Core n 409C). As further described herein, the network communication associated with the third core (Core n —409C) controls the first device (Device 1 —405A) based at least in part upon at least one command from the first vehicle control application associated with the first core (Core 1 —409A). As further described herein, the network communication associated with the third core (Core n —409C) controls the second device (Device 2 —405B) based at least in part upon at least one command from the second vehicle control application associated with the second core (Core 2 —409B). As further described herein, the network communication protocol comprises a deterministic network communication protocol. In one example, operative communication described herein between the first core (Core 1 —309A) and the third core (Core n —309C) may be carried out via use of the Shared Memory 407C. In another example, operative communication described herein between the second core (Core 2 —309B) and the third core (Core n 309C) may be carried out via use of the Shared Memory 407C.

Of course, the three cores shown in this FIG. 4 are intended to be an example, and any desired number of cores may be utilized. Further, the single memory shown in this FIG. 4 is intended to be an example, and any desired number of memories may be utilized. Further, the three memory locations shown in this FIG. 4 are intended to be an example, and any desired number of memory locations may be utilized. Further, the single shared memory shown in this FIG. 4 is intended to be an example, and any desired number of shared memories may be utilized. Further, the two devices shown in this FIG. 4 are intended to be an example, and any desired number of devices may be utilized. In another example, all or part of Memory 407 may reside within the Multicore Processor 403.

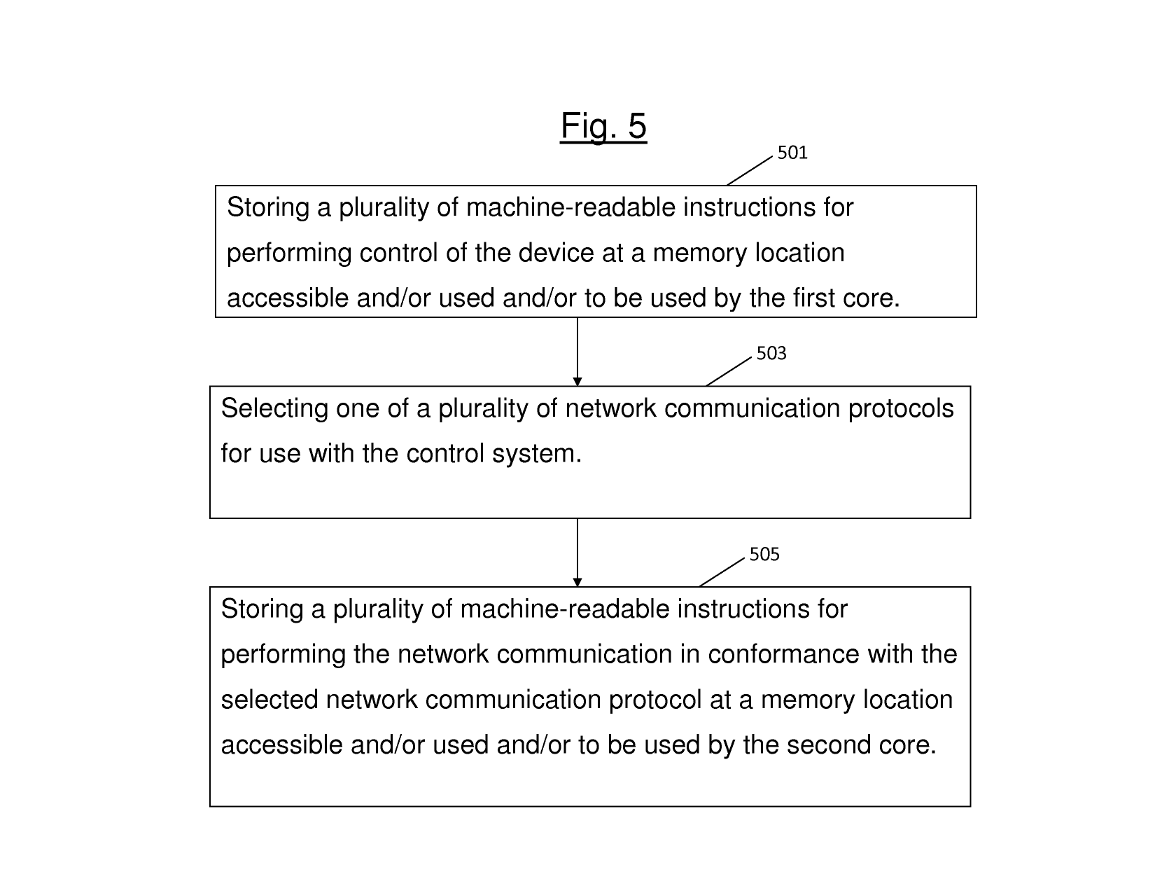

Referring now to FIG. 5, a block diagram of a method according to another embodiment of the present invention is shown. In one example, this method may apply to a control system for use with a vehicle. Of note, as mentioned herein, other embodiments of the present invention may be used in any other desired context (e.g., medical control system, hospital control system, instrumentation control system, test instrument control system, energy control system and/or industrial control system). In any case, the control system of this example uses a multicore processor to perform network communication with a device, wherein the multicore processor includes at least a first core and a second core, the method comprising: storing (at a memory location accessible and/or used by the first core) a plurality of machine-readable instructions for performing control of the device (Step 501); selecting at least one of a plurality of network communication protocols for use with the control system (Step 503); and storing (at a memory location accessible and/or used by the second core) a plurality of machine-readable instructions for performing the network communication in conformance with the selected network communication protocol(s) (Step 505). Further, in this example, the network communication associated with the second core is configured to control the device based at least in part upon at least one command from the plurality of machine-readable instructions for performing control of the device that are associated with the first core. In another example, the selected network communication protocol(s) comprise deterministic network communication protocol(s).

In another example, shared memory may be L2 cache (e.g., that is physically located on and/or internal to the multicore processor). In another example, any desired memory type may be utilized (e.g., SDRAM, DDRI/2/3/4, MRAM, SRAM, etc.). In another example, any desired internal memory structure on or within the multicore processor may be utilized and/or any desired external memory type may be utilized.

As described herein, various embodiments of the present invention may provide for enhanced system performance (while reducing cost and complexity), via use of one core of a multicore processor to host one or more high speed communication buses (such as, for example, AFDX or TTEthernet). In one specific example, this architecture eliminates the need for a separate processor, FPGA, or ASIC and associated memory and devices to host the high speed communication bus(es).

As further described herein, one example of the present invention may provide for a multicore processor that utilizes one of the processor cores and one or more enhanced triple speed Ethernet controllers (eTSEC) on the multicore processor port(s) to manage one or more deterministic network communication protocols. In one specific example, by varying the software executed by one of the processor cores any desired deterministic network communication protocol (e.g., an ARINC 664 Part 7 protocol; a Time-Triggered Ethernet—SAE AS6802 protocol; or an IEEE 1588 protocol) can be accommodated by a single multicore processor hardware design. Such a design according to one example of the present invention may reduce the typically high costs of designing a new ASIC or FPGA for a given control system (and/or its derivatives) when a different network communication protocol (e.g., deterministic network communication protocol) is required. Further, such a design according to one example of the present invention may eliminate the need for a separate ASIC, FPGA, or microprocessor (as has traditionally been required to host a high speed communication bus such as AFDX or TTEthernet). Further still, such a design according to one example of the present invention may provide (relative to a traditional design): (a) reduced cost; (b) reduced board area; (c) reduced weight; (d) reduced complexity; (e) off-loading of processing from main processor; (f) enhanced upgrade capability; and/or (g) configurable data rate.

Further, as described herein, in various examples of the present invention a multicore processor (such as from the Freescale Semiconductor™ QorIQ family) may contain multiple built-in Ethernet controllers and DMA controllers that can be used to process high speed bus data independent from the designated “main” processor core(s).

In another example, in a design architecture according to an embodiment of the present invention the communication bus data may be exchanged (e.g., exchanged essentially instantly) between cores using shared memory such as DDR or L2 Cache.

In another example, in a design architecture according to an embodiment of the present invention a multicore processor may enable easy synchronization and/or arbitration of the communication bus between cores.

In other examples, the present invention may be applied to commercial use and/or to military use.

In other examples, the present invention may be applied in the context of avionics use.

In other examples, any desired number of multicore processors (e.g., one or a plurality) may be used in connection with a given vehicle.

In other examples, any desired number of buses (e.g., one or a plurality) may be used in connection with a given vehicle.

In other examples, any desired number of devices (e.g., one or a plurality) may be used in connection with a given vehicle.

In other examples, one core may control a plurality of devices and/or one vehicle control application may control a plurality of devices.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment or an embodiment combining software and hardware aspects. Furthermore, aspects of the present invention may take the form of a computer program product embodied in one or more computer readable medium(s) having computer readable program code embodied thereon. In one example, the computer readable medium may tangibly embody the program code in a non-transitory manner.

In another example, resident firmware (i.e., part of a multicore processor, as opposed to a separate FPGA firmware based device) may be utilized. In another example, a combined hardware and software solution that eliminates the need for external firmware may be provided.

In another example, any desired deterministic (e.g., Ethernet based) protocol(s) may be utilized as the network communication protocol(s). In another example, any desired non-deterministic (e.g., Ethernet based) protocol(s) may be utilized as the network communication protocol(s).

In another example, a system may be provided with a dedicated core to communicate with a device connected to a communication network (e.g., a deterministic communication network). In one specific example, this may be carried out by using appropriate software and/or appropriate architecture.

In another example, a system may be provided with a plurality of dedicated cores to communicate with a plurality of respective devices connected to a communication network (e.g., a deterministic communication network). In one specific example, this may be carried out by using appropriate software and/or appropriate architecture.

In another example, a method may provide a dedicated core to communicate with a device connected to a communication network (e.g., a deterministic communication network). In one specific example, this may be carried out by using appropriate software and/or appropriate architecture.

In another example, a method may provide a plurality of dedicated cores to communicate with a plurality of respective devices connected to a communication network (e.g., a deterministic communication network). In one specific example, this may be carried out by using appropriate software and/or appropriate architecture.

In another example, one or more nondeterministic protocols may be used and/or buffered by a deterministic core (that is, a core associated with (and/or dedicated to) one or more deterministic protocols).

In another example, a deterministic core (that is, a core associated with (and/or dedicated to) one or more deterministic protocols) may buffer (and/or help buffer) one or more other cores from the lack of network determinism in connection with one or more non-deterministic networks associated with such other core(s).

Computer program code for carrying out operations for aspects of the present invention may be written in any desired language or in any combination of one or more programming languages, including (but not limited to) an object oriented programming language such as Java, Smalltalk, C++ or the like or a procedural programming language, such as the “C” programming language or similar programming languages.

Aspects of the present invention are described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Further, these computer program instructions may be stored in a computer readable medium that can direct a computer, other programmable data processing apparatus, or other device(s) to function in a particular manner, such that the instructions stored in the computer readable medium produce an article of manufacture including instructions which implement the function/act specified in the flowchart and/or block diagram block or blocks.

Further, these computer program instructions may be loaded onto a computer, other programmable data processing apparatus, or other device(s) to cause a series of operational steps to be performed on the computer, other programmable apparatus or other device(s) to produce a computer implemented process such that the instructions which execute on the computer or other programmable apparatus or other device(s) provide processes for implementing the functions/acts specified in the flowchart and/or block diagram block or blocks.

The flowcharts and/or block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the function(s) noted in the block may occur out of the order noted in the figures. For example, two blocks shown in succession may, in fact, be executed substantially concurrently, or the blocks may sometimes be executed in the reverse order, depending upon the functionality involved.

It is noted that the foregoing has outlined some of the embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. Further, it is noted that all examples disclosed herein are intended to be illustrative, and not restrictive.

What is claimed is:

1. A control system, wherein the control system uses a multicore processor to perform network communication with a device, the control system comprising:
a memory including at least a first memory location and a second memory location;
at least a first core for executing a control application, wherein the first core is part of the multicore processor, wherein the control application comprises a plurality of machine-readable instructions, wherein the machine-readable instructions of the control application are stored at the first memory location and are accessible by the first core; and
at least a second core for executing a network communication with the device, wherein the second core is in operative communication with the first core, wherein the network communication conforms with a communication protocol, and wherein a plurality of machine-readable instructions for performing the network communication in conformance with the communication protocol are stored at the second memory location and are accessible by the second core;
wherein the network communication associated with the second core controls the device based at least in part upon at least one command from the control application associated with the first core.

2. The system of claim 1, wherein the control application is a vehicle control application and the vehicle is selected from the group consisting of: (a) an aerospace vehicle (b) a ground vehicle; (c) a boat; (d) a ship; and (e) a submarine.

3. The system of claim 1, wherein the device is selected from the group consisting of: (a) an engine; (b) a motor; (c) an actuator; (d) a control surface, (e) a navigation device; and (f) a communication device.

4. The system of claim 1, wherein:
the multicore processor includes at least one Ethernet controller; and
the Ethernet controller provides, for the network communication, input to and output from the multicore processor.

5. The system of claim 1, wherein the network communication protocol is a deterministic network communication protocol that comprises at least one of (a) an ARINC 664 Part 7 protocol; (b) a Time-Triggered Ethernet—SAE AS6802 protocol; and (c) an IEEE 1588 protocol.

6. The system of claim 1, wherein the at least one command from the control application associated with the first core is based at least in part upon at least one feedback datum provided to the first core via the network communication associated with the second core.

7. A control system, wherein the control system uses a multicore processor to perform network communication with a first device and a second device, the control system comprising:
a shared memory;
at least a first core for executing a first control application, wherein the first core is part of the multicore processor, wherein the first control application comprises a plurality of machine-readable instructions, wherein the machine-readable instructions of the first control application are stored at a first memory location accessible by the first core, and wherein the shared memory is accessible by the first core;
at least a second core for executing a second control application, wherein the second core is part of the multicore processor, wherein the second control application comprises a plurality of machine-readable instructions, wherein the machine-readable instructions of the second control application are stored at a second memory location accessible by the second core; and wherein the shared memory is accessible by the second core; and
at least a third core for executing a network communication, wherein the network communication conforms with a network communication protocol, wherein a plurality of machine-readable instructions for performing the network communication in conformance with the network communication protocol are stored at a third memory location accessible by the third core, wherein the shared memory is accessible by the third core, and wherein at least some network data associated with the network communication is made available in the shared memory by the third core;
wherein each of the first core and the second core has access to at least some of the network communication data made available in the shared memory by the third core.
wherein the first core is in operative communication with the third core and the network communication associated with the third core controls the first device based at least in part upon at least one command from the first control application associated with the first core; and
wherein the second core is in operative communication with the third core and the network communication associated with the third core controls the second device based at least in part upon at least one command from the second control application associated with the second core.

8. The system of claim 7, wherein the control application is a vehicle control application and the vehicle is selected from the group consisting of: (a) an aerospace vehicle (b) a ground vehicle; (c) a boat; (d) a ship; and (e) a submarine.

9. The system of claim 7, wherein each of the first and second devices is selected from the group consisting of: (a) an engine; (b) a motor; (c) an actuator; (d) a control surface, (e) a navigation device; and (f) a communication device.

10. The system of claim 7, wherein:
the multicore processor includes an Ethernet controller; and
the Ethernet controller provides, for the network communication, input to and output from the multicore processor.

11. The system of claim 7, wherein the network communication protocol is a deterministic network communication protocol that comprises at least one of: (a) an ARINC 664 Part 7 protocol; (b) a Time-Triggered Ethernet—SAE AS6802 protocol; and (c) an IEEE 1588 protocol.

12. The system of claim 7, wherein the shared memory comprises at least one of: (a) DDR memory; and (b) L2 Cache memory.

13. The system of claim 7, wherein:
the at least one command from the first control application associated with the first core is based at least in part upon at least a first feedback datum provided to the first core via the network communication associated with the third core; and
the at least one command from the second control application associated with the second core is based at least in part upon at least a second feedback datum provided to the second core via the network communication associated with the third core.

14. A method for use in connection with a control system, wherein the control system uses a multicore processor to perform network communication with a device, wherein the multicore processor includes at least a first core and a second core, the method comprising:
storing a plurality of machine-readable instructions for performing control of the device at a memory location to be used by the first core;
selecting one of a plurality of network communication protocols for use with the control system; and
storing a plurality of machine-readable instructions for performing the network communication in conformance with the selected network communication protocol at a memory location to be used by the second core;
wherein the network communication associated with the second core is configured to control the device based at least in part upon at least one command from the plurality of machine-readable instructions for performing control of the device that are associated with the first core.

15. The method of claim 14, wherein the plurality of machine-readable instructions for performing control of the device comprise a vehicle control application and the vehicle is selected from the group consisting of: (a) an aerospace vehicle (b) a ground vehicle; (c) a boat; (d) a ship; and (e) a submarine.

16. The method of claim 14, wherein the device is selected from the group consisting of: (a) engine; (b) a motor; (c) an actuator; (d) a control surface, (e) a navigation device; and (f) a communication device.

17. The method of claim 14, wherein:
the multicore processor includes an Ethernet controller; and
the Ethernet controller provides, for the network communication, input to and output from the multicore processor.

18. The method of claim 14, wherein the selected network communication protocol is a deterministic network communication protocol that comprises at least one of: (a) an ARINC 664 Part 7 protocol; (b) a Time-Triggered Ethernet—SAE AS6802 protocol; and (c) an IEEE 1588 protocol.

19. The method of claim 14, further comprising:
executing the machine-readable instructions for performing the selected network communication in conformance with the selected network communication protocol; and
executing the machine-readable instructions for performing control of the device.

20. The method of claim 14, wherein the steps are carried out in the order recited.
